(19) United States
(12) Patent Application Publication
(10) Pub. No.: US 2007/0240529 A1
(43) Pub. Date: Oct. 18, 2007

(54) Planetary gyroscopic drive system

(76) Inventor: Craig Howard Zeyher, Haddonfield, NJ (US)

Correspondence Address: CRAIG H. ZEYHER, 131 RHOADS AVENUE, HADDONFIELD, NJ, 08033-1414, US

(21) Appl. No.: 11/405,172

(22) Filed: Apr. 17, 2006

(51) Int. Cl. G01C 19/46

(52) U.S. Cl. 74/5.44

(57) ABSTRACT

This invention relates to a universal drive system employing gyroscopic principals of operation. Central to the system is maintenance of rotor inertia through forced precession. It preferred use is for the generation of electric power. Other uses, such as an auxiliary automotive drive system, fan or mobile display are within the scope of its application. Operation is initiated by bringing the rotor up to speed and offsetting its axis of rotation causing precession. The rotor's inertia and its natural tendency to restore itself to its original position of equilibrium, prior to being offset, are utilized through mechanical design to utilize this restorative force to produce a counter force which acts upon the spinning precessing gyro (rotor) automatically to sustain its inertia and precessional motion.

This invention relates to a drive system utilizing gyroscopic principles of operation.

I have developed a unique and highly efficient drive system utilizing gyroscopic principals of operation. It is known that a complex motion, known as precession, occurs when a rotating body is subjected to a torque tending to change its axis of rotation. I have devised means whereby this precessional motion can be utilized in producing an efficient drive system through selective application of force to the rotational axis of the rotating body as it moves along its precessional path. These forces are designed to occur automatically and without the need to intervene once operating parameters are established and mechanically implemented into the design as illustrated and described in connection with illustrative embodiments.

Following is a detailed description of the preferred embodiment of the invention.

I have discovered that by applying a predetermined force of either constant or intermittent duration to the precessing axis of a spinning gyro that a sustained rotational force can be produced and maintained with minimal expenditure of energy.

When the axis of rotation of the rotor is offset the rotor precesses and exerts a force acting to restore the rotor to its original position. I have discovered that rotor rotation can be maintained with minimal energy input if the restorative force is opposed by applying an opposite and equal force to the rotor's rotational axis and directing the resultant of these two forces to aid the precessional motion of the offset spinning precessing rotor. To maintain this operational mode continuously and automatically I have invented a structural arrangement for achieving this end.

When the spin axis of a rotating body is offset the rotating body tends to speed up in accordance with the law of conservation of angular momentum. When this occurs the precessional axis moves in a conical locus and attempts to return to its original position in accordance with gyroscopic principals. I have found that by modulating a force which assists the precessional motion, the rotational speed of the system can be regulated with minimal energy input. This phenomenon in turn can be used as a drive means for any number of applications.

With the rotor offset and exerting a force acting to restore it to its original position this “restorative” force is opposed by applying a force consisting of two components, an opposing component and a component assisting the rotor's rotation and precessional motion. The opposing component is in direct opposition to the restorative force while the assisting component aids the precessional motion of the offset spinning and precessing rotor. The restorative force is opposed automatically by providing a plate backed by a spring which is compressed by the restorative force. The precessing force is assisted by skewing this plate to produce a resultant force helping to maintain operational speed and precessional motion. This mode of operation for maintaining the rotational speed of the rotor can be achieved in a number of ways but in one example this is achieved by a plate backed by a spring which is compressed by the careful and measured extension of the extension arms connected to the inner platform which carries the rotor assembly and by adjustment of the positioning of the spring backed plate.

Simultaneously to opposing the restorative force a component of this same restorative force is used to assist the precessional motion of the offset spinning and precessing rotor by applying a constant moving force delivered to the inner platform behind the spinning rotor axle. at a rate which neither overrides nor under rides the precessional motion of the precessing rotor but rather gently applies force behind this precessing axle causing the rotor axle to be driven ahead of this constant force.

The above described operation is achieved through careful and measured adjustment of pressure exerted upon the plates and springs and by use of two specially weighted rolling ball bearing type assemblies which are used to position the plate. The resulting torque, rate of spin and precessional speed of the spinning precessing rotor can be monitored through means common to the art, laser timing devices and computer feedback and analysis

Careful placement and extension of the extension arms is required to attain maximum effective driving force from reaction to the spring backed plates. The extension arms can be curved (best seen in FIG. 2A) where they contact the inner platform track so as to achieve a more direct vectoring of force in assisting the precessional motion of the precessing rotor and inner platform. Precessional motion can also be aided by skewing of the spring backed plate to produce a precessionally directed force component.

With the rotor maintaining its rate of spin the restorative torque force is maintained and this in turn maintains the reactionary force utilized to maintain system operation.

Described and illustrated below are mechanical means for achieving this unique mode of operation. It is to be understood however that this invention is not limited to the precise embodiment or application described.

### DRAWINGS

FIG. 1 is a sectional view of a drive mechanisium employing magnetic elements designed to implement the above described system of operation.

FIGS. 2A and 2B depict an alternative design using ball bearing races and a motor drive aid.

FIG. 3 depicts details of a motor drive aid.

FIG. 4 shows a sectional cross section taken along the cutting plane 44 of FIG. 1.

FIG. 5 Depicts a Gyroscope and its torque axis, spin axis and precessional axis.

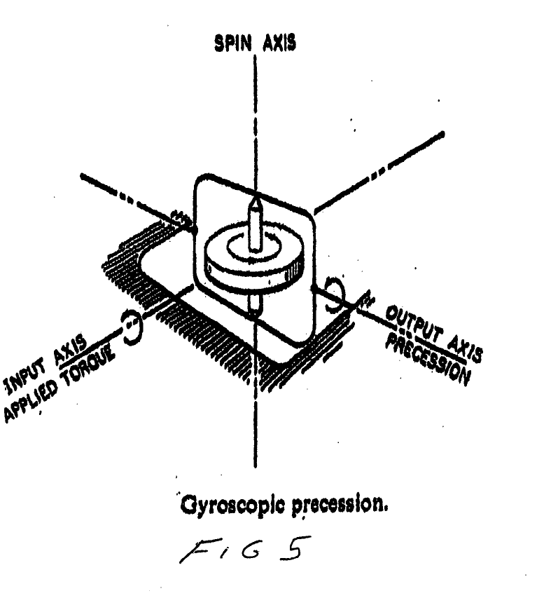

FIG. 6 Is an enlarged view of the central section of FIG. 10.

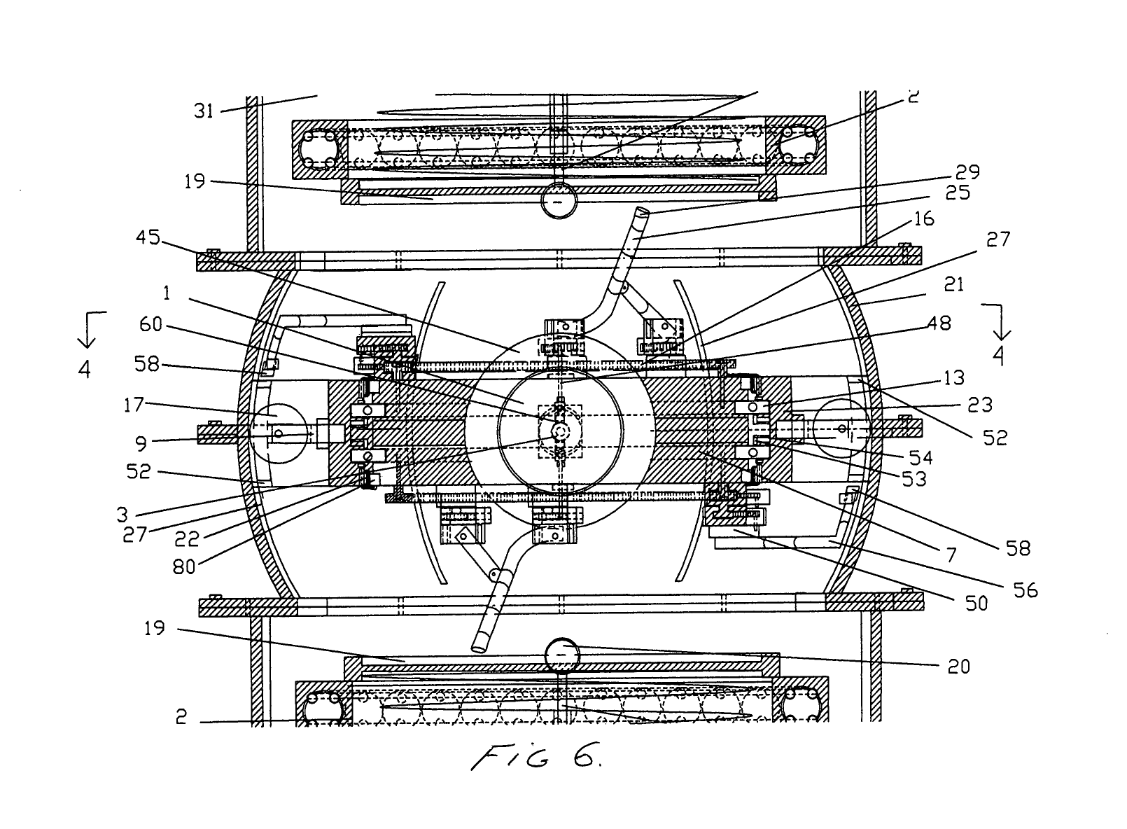

FIG. 7 Shows the use of a telescoping arm to insure coordination of the weighted ball assembly (2) with the precessing rotor assembly.

FIG. 8. Is an enlarged view showing details of the weighted ball assembly.

FIG. 9. Is a segmented front view showing the invention utilized as a generator along with stabilizing apparartus.

FIG. 10. Is a segmented side view showing the invention utilized as a generator along with stabilizing apparatus.

### DETAILED DESCRIPTION OF THE INVENTION

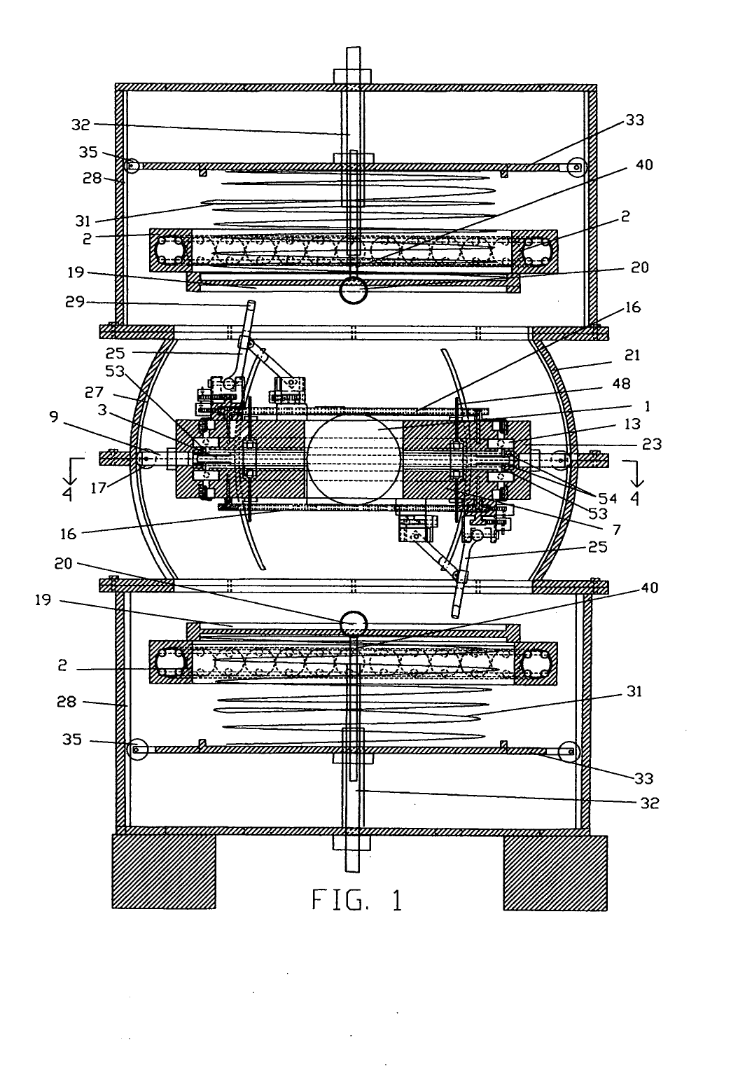

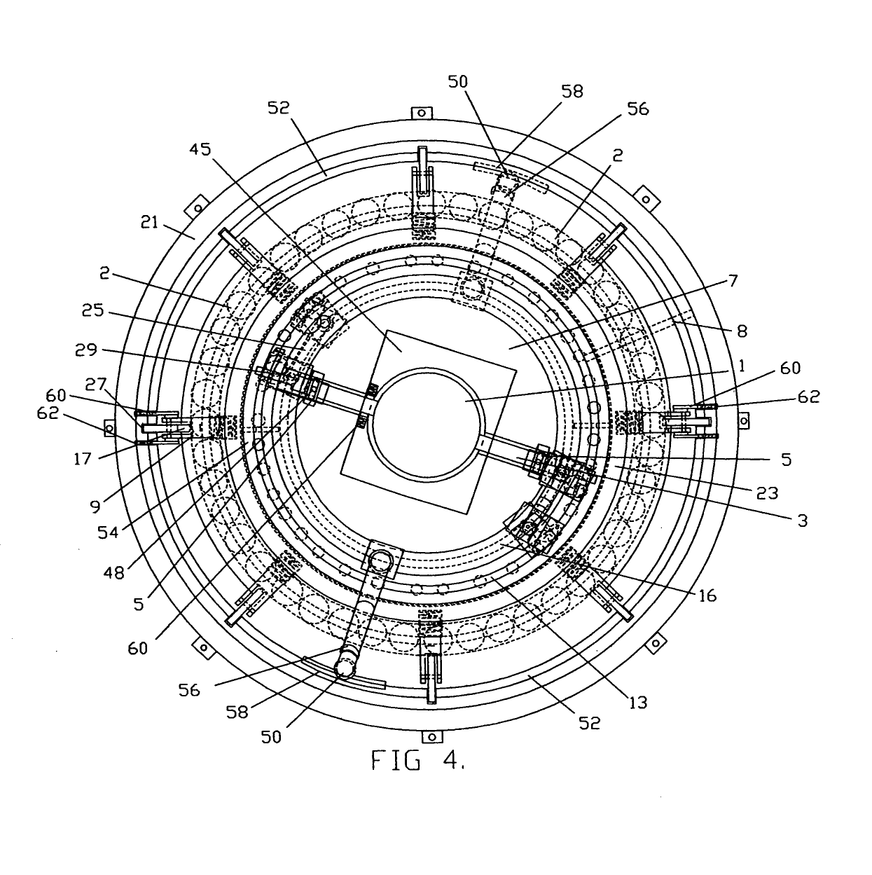

Referring to FIG. 1 there is shown a constant drive mechanism employing gyroscopic principals of operation. A sphere or cylinder (1), herein referred to as a rotor, is mounted for rotation relative to an outer platform (23) by means of ball bearing assemblies (13) interposed between inner platform (7) and outer platform (23) (best seen in FIG. 4.). This arrangement permits rotation of the rotor axle and inner platform (7) in a direction perpendicular to the axis of rotation of the rotor (1) and provides two degrees of freedom in the gyroscopic movement of the assembly. The outer platform (23) is mounted for movement relative to the fixed housing (21) through support arms (9) mounted with ball bearings or wheels (17) having minor pivotal capability which ride in tracks (27) provided in the wall of housing (21). This arrangement permits platform (23) to execute a complex wobbling or undulating motion.

A spinning rotor (1) when subject to a torque* tending to change its axis of rotation causes precessional motion **of the rotating body and a resulting force tending to restore it to its original position. Modulation of the resulting force can be used to control the rotational speed of the gyro. The preferred mode of operation is to oppose the resulting force by a counter force producing a component of force directed upon the spin axis to assist in the precessional motion of the gyro as it moves along its precessional path. **

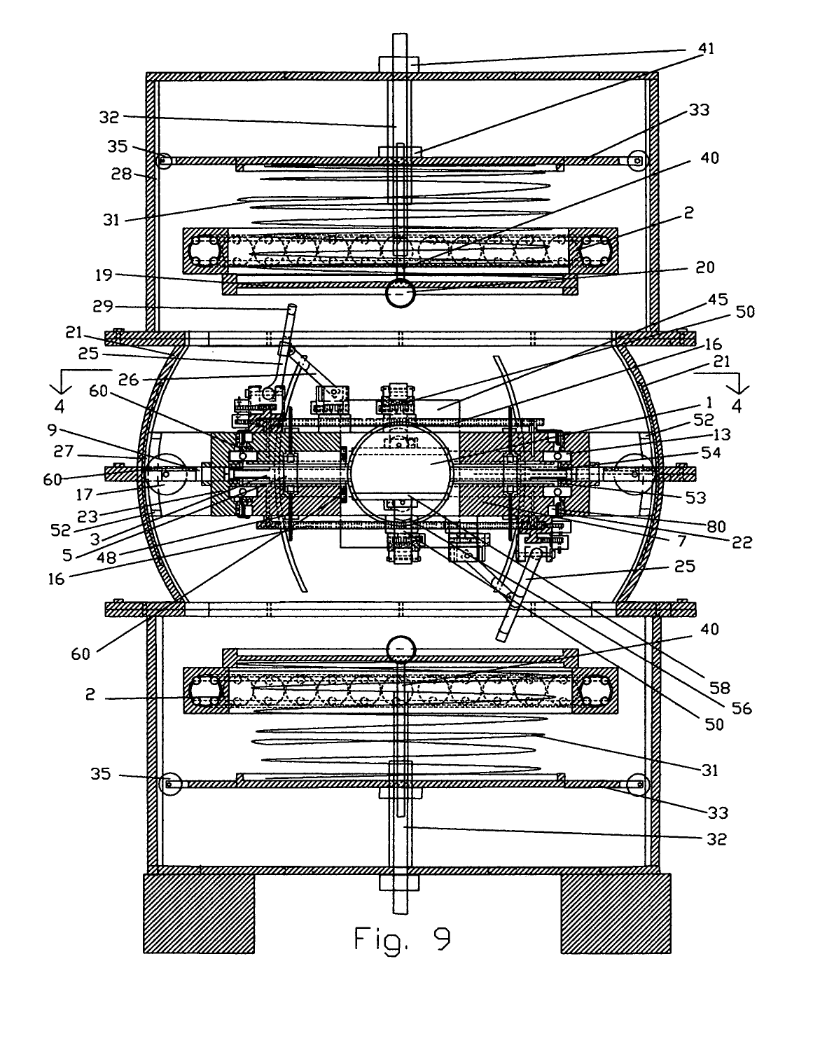

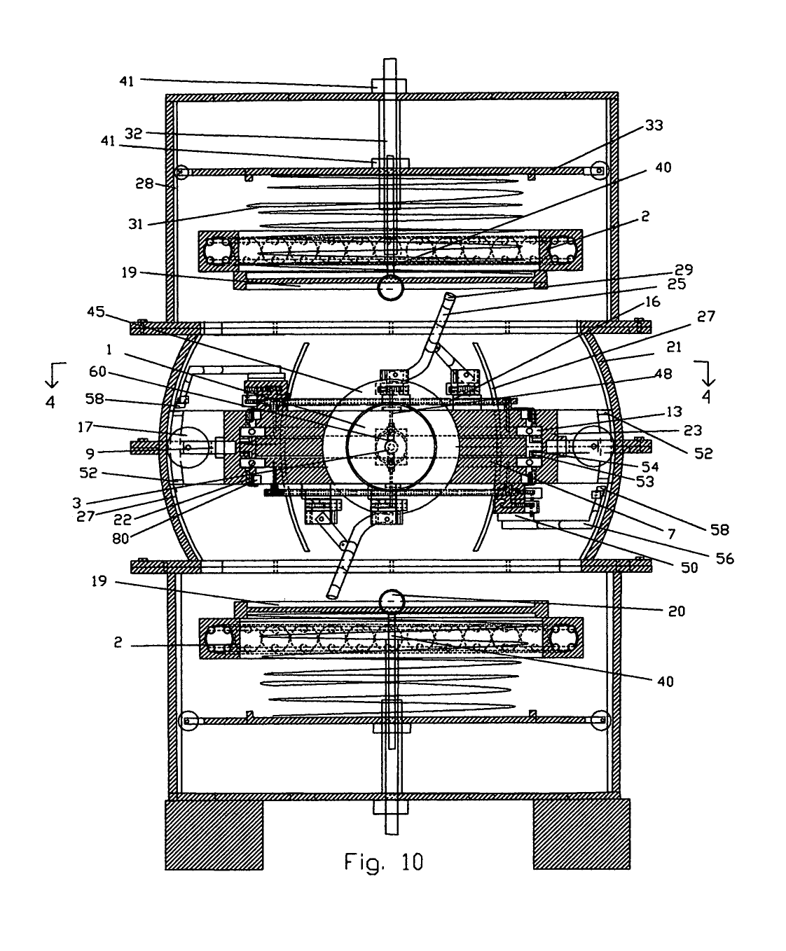

Rotor 1 (best seen in FIG. 4) is initially brought up to speed by engaging a clutch drive through a hole (8) in the outer housing and inner platform to engage the end of the rotor axle (3) or by operating the rotor as an electric motor.(Motor and Generator components are not shown in FIG. 1 but are common to the art and are shown in FIGS. 9 and 10). Once the rotor is brought up to speed platform (23) is tilted through extension of remotely controlled servo operated telescoping extension arms (25) as seen in FIG. 1, equipped with magnetic ends (29). The spring backed plates (19) are magnetic on the inner surface facing the rotor and of similar polarity to the magnetic tipped extension arms so as to repulse each other. A lip can be employed as a precautionary measure, on the edge of the magnetic plate (19) to insure that upon extension of extension arms (25) the two components remain in operational proximity to each other.

Extension arms are located on either side of the inner platform (7). One on the upper side and one on the lower side are located so as to achieve tilting of the platform assembly and rotor spin axis while simultaneously compressing the springs (31). Weighted ball bearing type assemblies (2) are used to skew the spring backed plates (19) in a direction to produce a force component assisting precessional motion of the tilted rotor. Regulating the speed of rotation is achieved in a number of ways. Through motor (41) driven extension arms (32) and (40) adjustment to plates (33) and (19) can be made both in the spring tension and proximity to the rotor (1) assembly.
* see addendum 1
** see addendum 2

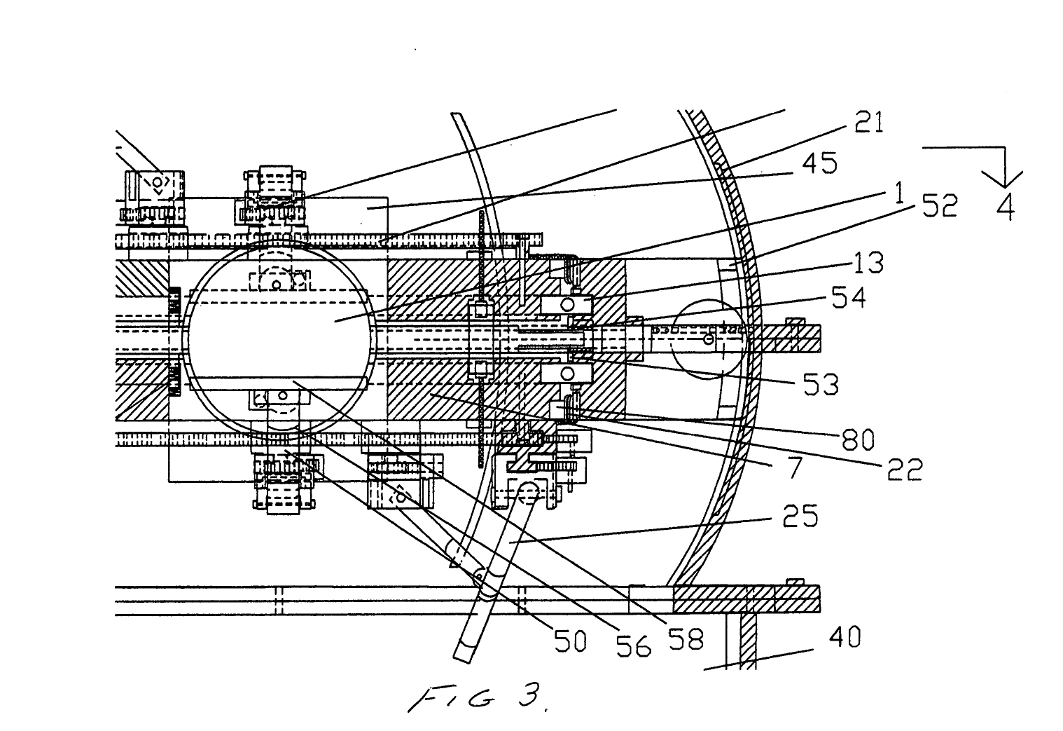

Speed is also regulated through frictional contact. Frictional contact is adjustable between the rotor axle (3) and rings (54) located above and below the ends of the rotor axle located in outer platform (23) and is achieved by a remotely controlled servo screw or servo operated hydraulic lift (53) best shown in FIG. 3. Through this and other means to be described adjustment can be made to vary friction from none to substantial. Contact between the ends of the rotor axle and rings (54) can also be made such that one end of the axle can contact the lower ring and the other end of said axle can contact the upper ring. This arrangement is constructed so as not to inhibit rotor motion by having the opposite ends of the axle attempting to move in opposition to each other. An alternative is to employ a counter rotation device. (Through such a device the rotational motion of the axle can be reversed so that driving contact can be made on to the same ring without inhibiting its forward motion).

Another means for controlling frictional contact of the rotor axle with rings (54) is through adjustment of the ball bearings carrying the rotor axle. This is accomplished through use of a remotely controlled motor or servo operated screws (48) shown in FIG. 3. which connecting to rotor axle ball bearings (5).

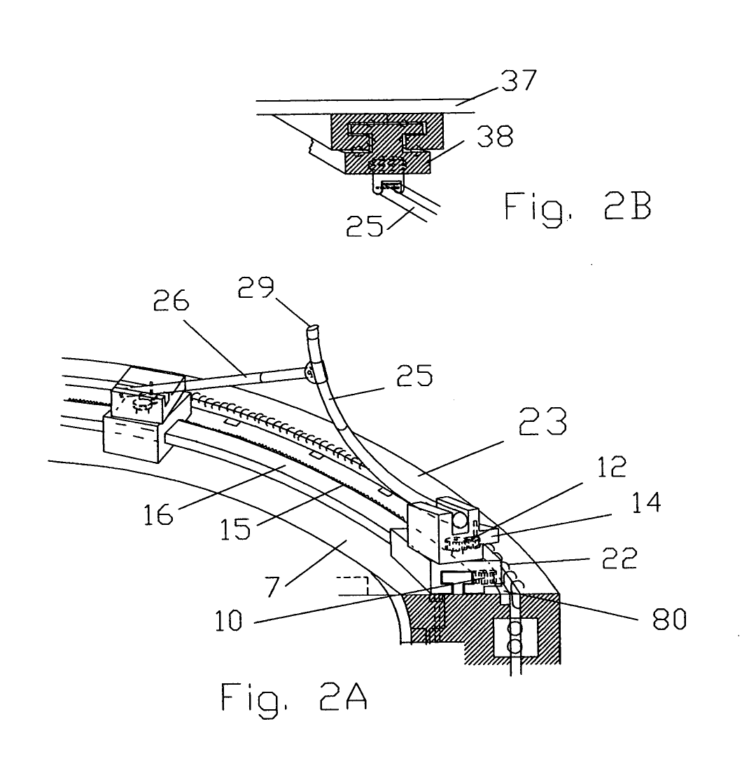

In addition to tilting the platform and rotor spin axis the telescoping of the extension arms (25) (seen in FIG. 1) also results in the spring backed magnetic backed plates (19) being tilted and put under pressure. *** This is in response to the upward (or downward—when referring to the lower half of the assembly) force exerted through the extension arms (25) due to the rotor seeking to restore itself to its original position of relative equilibrium. To achieve a more directionally focused opposition force the spring backed plates (19) are skewed through use of assembly (2). The magnetic tips (29) of extension arms (25) are best seen in FIG. 2A. Magnetic plates (19) are of the same polarity. When in operation the two magnetic components repulse each other.

The result of this arrangement is to create a vectored force acting in response or reaction to the tilted rotors torque in order to augment its precessional motion.

Shielding or use of nonmagnetic materials may be necessary in areas adjacent the
*** see addendum 3
   magnetic fields to insure proper operation. The plates (19) are magnetized on the inner surface opposite extension arms (25) and require magnetic shielding on the opposite surface so as not to interfere with the springs (31)and weighted ball bearing assembly (2).

Positioning of extension arms (25) and magnetic tips (29) to achieve maximum benefit is critical, hence they are designed both in their individual parts construction and in their mounting to a track (16) attached to platform (7) to be movable, adjustable, pivotal and lockable through conventional means. This is best seen in FIG. 2A which shows remotely controlled servo gear (12) for pivoting and locking extension arms (25) and remotely controlled motor (14) for locking the base of the extension arm (25) to track (16). Remotely controlled motor or servo operated gear (10) can be utilized to move and lock the adjustment apparatus along track (16) via geared track (15). Extension arms (25) are also equipped with adjustable support braces (26) which are also movable on the track (16) provided on the inner platform (7) and also lockable through conventional means. Referring to FIGS. 1, 9 and 10 pressure adjustment to the magnetic plates (19) backed by springs (31) is achieved through adjustable plate (33). Both plates (33) and (19) can be further adjusted and stabilized by remotely controlled servo operated or hydraulic operated extension arms (32) and (40). Extension arm (40) connects to platform (19) through a ball bearing arrangement (20) which allows swivel movement of plate (19). Both extension arms (32) and (40) and plates (19) and (33) are used to adjust pressure or tension on the system to help regulate speed. Ball bearings or wheels (35) located on the sides of plate (33) help guide the plate along the inner wall of outer housing (21) through tracks (28) provided on the inner wall of housing (21). Hydraulic or servo motor (41) is used to power extension arms (32) and (40) in there adjustment capacity.

An alternative to the magnetic disk (19) and magnetic tipped extension arms (25) is shown in FIG. (2b). In this embodiment extension arms (25) attach to a circular ball bearing assembly (38) mounted to a non magnetic plate (37) (substitute for magnetic plate (19) in the above example), This permits motion similar to that previously discussed and illustrated in FIG. 1. The purpose of the magnets in the basic design is for the reduction of friction losses but can be replaced by the ball bearing assembly alternative just described.

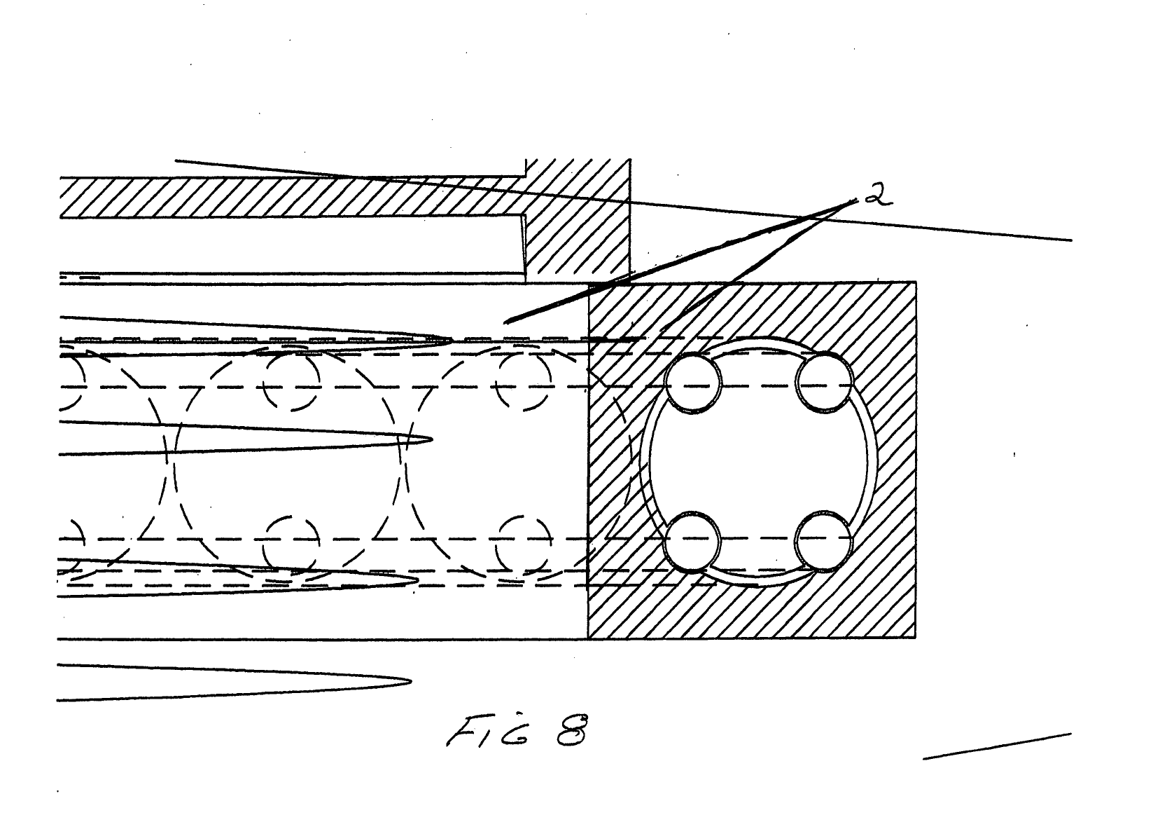

The weighted rolling ball assembly (2) attaches to plate (19) as best seen in FIGS. 1, 9 and 10. The weighted balls in this assembly are designed to constantly shift with and skew the plate (19) in coordinated motion with the precessing rotor assembly. This is done to achieve greater force directed against the extension arm (25) and inner platform (7) to aid the rotors precessional motion and permits the rotor assembly to be pushed by the reactionary force. The individual balls in this assembly are individually weighted and are individually carried by ball bearings through a track (best seen in FIG. 8). Movement of the weighted balls is through gravitational force which results when platform (19) and platform (2) are offset by extension arms (25).

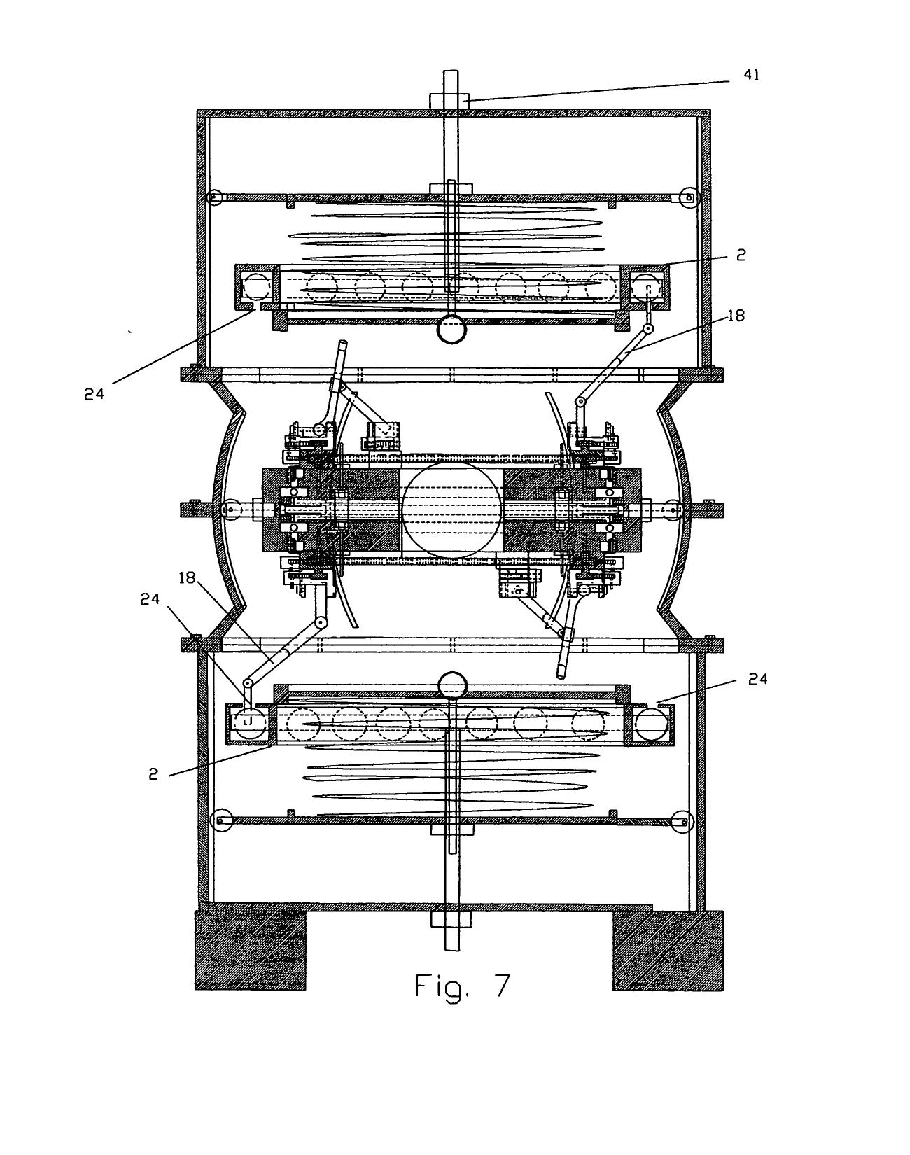

An assisting element to the use of gravity is shown in FIG. 7 where a telescoping arm (18) is employed. Here the telescoping arm (18) connects to the inner platform (7) in a fashion similar to the previously discussed extension arms (25). The other end of the rod would extend into the weighted ball assembly (2) through a channel (24) cut in the assembly. Through utilization of a ball bearing race carrying the weighted balls and a pivotal connection to the extension arm (18) the arm (18) would then be in a position to push behind a strategically chosen weighted ball. This would insure coordinated movement of the weighted balls and tilting of plate (19) with the precessional motion of the rotor (1) and inner platform (7).

The weighting and placement of individual balls is different in each of the two assemblies (above and below the rotor) but the purpose remains the same. Weighting of these balls depends upon spring pressure, torque, and leverage.

To insure continued precessional motion of the rotor (1) and platform (7), the platform (7) and platform (23) can be equipped with a motor (or similar drive apparatus). This would require some modification depending upon the drive utilized as is typical of the art. For example, the assemblies may need to be made of non-magnetic material, such as ceramic or insulation of the ball bearing assembly (13) may be required. One example of such a motor drive assist consisting of motor and ball bearing assembly is shown in some detail in FIGS. (2 & 3) where magnets (80) attach to the outer edge of the inner platform (7) to be driven electrically by a rotating magnetic field circulating in conductors (22) on the outer platform (23). It should be noted however that other drive arrangements are possible.

The system described can be used with some modification for powering a number of devices, such as a rotor of a generator, or for use as a fan among other uses. Naturally some modification such as electrical or magnetic insulation or shielding of magnetic lines of flux or for protecting against excessive heat may be required, as is understood in the art. The basic system described requires sufficient weighting of the rotor to maintain required inertia affects.

The drawings are not to scale.

FIG. 4 is a sectional plan view of FIG. 9 taken along the cutting plane 4-4. The rotor assembly shown is modified for use as an electric generator by means common to the art. The gyroscopic drive principal remains as described above. First the generator rotor is brought up to operating speed by either external means, a frictional or gear driven apparatus inserted through a hole (8) engaging the end of the rotor axle or by operating the generator as a motor until sufficient speed is achieved. Once sufficient operating speed is achieved the initial drive power to the rotor is disengaged and the extension arms (25) (shown in FIGS. 1, 9 & 10) are extended. With proper placement of the telescoping remotely controlled servo operated extension arms (25) the spin axis is tilted such that precessional motion occurs.

Extension of these arms also results in the weighted ball bearing assembly (2) coming in to play such that it tilts the spring backed plate (19) creating a more focused force reaction to the precessing rotor assembly. Hence the tilted precessing rotor in seeking to restore itself to its original horizontal position creates the force which is utilized to assist the precessional motion.

With careful adjustment of spring tension, placement of extension arms, contact of the rotor axle with its counterpart frictional element and any additional needed motor driving force (if needed), a system of high operating efficiency results.

FIGS. 9 and 10 show an example of the system utilized as a generator or motor. In these examples the rotor would produce a counter torque in the stator or armature (45) attached to the inner platform (7) opposite in direction to that of the spinning rotor. To insure this counterforce does not adversely affect the precessional motion of the spinning rotor a restraining or stabilizing apparatus (50) can be employed.

One example of a stabilizing assembly can be seen best in FIGS. 9 and 10. A ledge having a magnetic quality is located on the inside wall of the outer housing. (This ledge has sections cut out of it to allow the support wheels (17) to pass through it. Remotely controlled servo operated telescoping arms (56) are attached to the inner housing in a manor similar to that of the aforementioned telescoping extension arms (25). These telescoping remotely controlled arms are equipped with rotatable, pivotal and lockable adjustable magnetic plates (58) of the same polarity as the magnetic ledge (52). When the rotor assembly is offset these plates pivot to maintain a surface parallel to the magnetic ledge. Torqueing of the inner and outer platform is hence restricted by the repulsive action between the plates (58) and the ledge (52) preventing over torqueing of the assembly in response to the rotor (1) being run as a generator or motor. Stabilizing arms are located on either side of the inner platform and are located roughly 90 degrees or perpendicular to the rotor axle. The magnetic plates (58) need to be long enough to span the wheel tracks so as to remain effective in operation. Areas adjacent the magnetic fields would need to be made of non magnetic material or insulated so as not to adversely affect operation of the system.

One alternative to the above described magnetic stabilizing apparatus (50) is to replace the spaced magnetic ledge (52) with spaced ball bearing assemblies. The aforementioned magnetic plate (58) would be replaced with a non magnetic plate which could ride within the ball bearing assembly much like the assembly shown in FIG. (2B). The connection between the telescoping extension arm and the non magnetic plate would be pivotal and lockable as previously described in the stabilizing apparatus (50). The plates here again would need to be long enough to span the gaps made by the wheel tracks (27). Placement and use of the support assembly would remain as described in the magnetic stabilizing assembly.

Electric power can be supplied to or removed from the system by convention means, brushes (60) as shown in FIGS. 4, 9 and 10.

Coordination of components can be computer controlled.

Inertia requirements of rotor and assembly are dependent upon resistances.

Following is the formula for the period of precession

$$T = \frac{4 {π}^{2} Is}{Q Ts}$$

In which I is the moment of inertia and Ts the period of spin about the spin axis, and Q is the torque.

The result of this arrangement is a drive system of improved efficiency. This system could be used with some modification, common to the art, to power a rotor for a generator, fan, or other device. The point being that the drive system described has numerous applications beyond those noted in this disclosure.

The rotor needs to be weighted for inertia purposes.

Computerized monitoring of speed and pressure control can be employed for added efficiency. Individual parts such as the support wheels may need to be made of non magnetic materials or insulated as deemed necessary and common to the art.

### ADDENDUMS

Addendum 1.

Torque=Rate of Change of Angular Momentum

If the rotation occurred in time δt seconds, the rate of change of momentum is

$$Change in momentum per second = I {ω}_{x} \frac{δ θ}{δ τ}$$

and if the change is at a constant rate

$$\frac{δ θ}{δ τ}$$

is the angular velocity about the y axis ω_{y}

Change in momentum per second=I ωₓω_{y}ω_{y}

Hence the torque required to produce the change in direction is T=I ωₓω_{y}

This is the torque that must be applied to produce the change in angle and the direction of the vector is the same as the change in momentum. The applied torque may hence be deduced in magnitude and direction.

Torque Calculation:

A practical way to calculate the magnitude of the torque is to first determine the lever arm and then multiple it times the applied force.
If a force of magnitude F=______ N (I Newton=0.2248 lbs) at a distance r=______ m (1 meter (m)=100 cm or 39.37 in.)
in an orientation where r makes the angle 0=______ degrees with respect to the line
of action force, then the lever arm=______ m and the magnitude of the torque is t=______Nm.
   Addendum 2.

The force in a compressed spring is found from Hooke's Law,
F=k(^{L}Free−^{L} def)
Spring free length^{L} free
Spring length when deformed ^{L} def
Spring constant k
   or
F=ks

The amount s by which an elastic solid is stretched or compressed by a force is directly proportional to the magnitude F or the force provided the elastic limit is not exceeded.

Where k is a constant whose value depends upon the nature and dimension of the spring.

Because F is proportional to s, the average force F̅ while the body is stretched (or compressed) from its normal length by an amount s to it final length is

$$\overline{F} = \frac{{F}_{initial} + {F}_{final}}{2} = \frac{0 + ks}{2} = \frac{1}{2} ks$$

since the initial force is 0 and the final force is ks. The work done in stretching the spring is the product of the average force F̅=½ ks and the total elongation s, so that
W=PE= 1/2 ks
Addendum 3.

The fundamental equation describing the behavior of the gyroscope is:

$$T = \frac{ⅆ L}{ⅆ t} = \frac{ⅆ ( I ω )}{ⅆ t} = I α$$

Where the vectors t and L are, respectively, the torque on the gyroscope and its angular momentum, the scalar I is its moment of inertia, the vector ω is its angular velocity, and the vector α is its angular acceleration.

It follows from this that a torque t applied perpendicular to the axis of rotation, and therefore perpendicular to L, results in a motion perpendicular to both t and L. This motion is called precession. The angular velocity of precession Ωp is given by T=Ωp×L

I Claim:

1. A drive system comprising:
A gyro having at least two degrees of freedom;
Means initiating rotation of the gyro and generation of a force acting to restore rotation of the gyro about its original spin axis; and
Means acting in opposition to the restorative force to control precessional speed of rotation.

2. A drive system as described in claim 1 in which said means acting in opposition to the restorative force comprises a spring-backed plate adapted upon compression by said restorative force to produce an opposition force controlling the precessional speed of rotation.

3. A drive system as described in claim 2 in which said spring backed plate is automatically positioned to produce a continuing application of the opposition force to the rotational axis of the precessing rotor.

4. A drive system as described in claim 3 in which said spring backed plate is automatically positioned by a system of free running weighted balls arranged to position said spring-backed plate through gravity.
